(19) United States
(12) Patent Application Publication
(10) Pub. No.: US 2011/0150086 A1
(43) Pub. Date: Jun. 23, 2011

(54) METHOD FOR DISPLAYING DECODED VIDEO BIT STREAMS

(75) Inventors: CHUNG-I LEE, Tu-Cheng (TW); CHIEN-FA YEH, Tu-Cheng (TW); CHIU-HUA LU, Tu-Cheng (TW); CHENG-FENG TSAI, Tu-Cheng (TW); SHAN-CHUAN JENG, Tu-Cheng (TW); YU-FENG CHIEN, Tu-Cheng (TW)

(73) Assignee: HON HAI PRECISION INDUSTRY CO., LTD., Tu-Cheng (TW)

(21) Appl. No.: 12/825,348

(22) Filed: Jun. 29, 2010

(30) Foreign Application Priority Data
Dec. 22, 2009 (CN) 200910312014.6

(51) Int. Cl. H04N 7/26

(52) U.S. Cl. 375/240.12; 375/240.25; 375/E07.027

(57) ABSTRACT

A method for improving display speed of decoding video bit streams obtains the video bit streams from a storage system of a computer by a decoder, and decodes the video bit streams in a display block of a memory of the computer to obtain decoded images by the decoder. The method further selects an image from the decoded images by the decoder, and updates a reference image stored in a buffer block of the memory with the selected image.

### BACKGROUND

1. Technical Field

Embodiments of the present disclosure relate to image decoding technology, and particularly to a method for improving display speed of decoded video bit streams.

2. Description of Related Art

Currently, video bit streams are decoded by a codec to obtain decoded images, and the decoded images are firstly stored in a buffer block of a memory. To play the video, the decoded images have to be moved from the buffer block to a display block of the memory. However, if there are large numbers of decoded images need to be displayed, video playing may be discontinuous and slow while the CPU is kept too busy.

What is needed, therefore, is an improved method for improving display speed of decoding video bit streams.

### BRIEF DESCRIPTION OF THE DRAWINGS

FIG. 1 is a block diagram of one embodiment of a computer including a video decoder.

FIG. 2 is a flowchart of one embodiment of a method for improving display speed of decoding video bit streams.

FIG. 3 is a block diagram of one embodiment of decoding video bit streams.

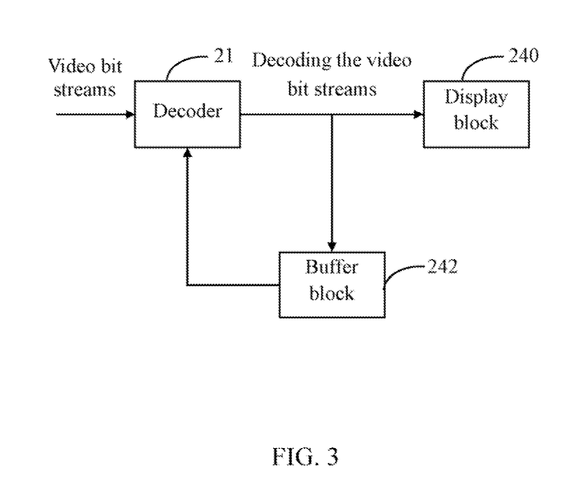

FIG. 4 is a detailed flowchart of one embodiment of block S2 in FIG. 2.

### DETAILED DESCRIPTION

All of the processes described below may be embodied in, and fully automated by, functional code modules executed by one or more general purpose computers or processors. The code modules may be stored in any type of readable medium or other storage system. Some or all of the methods may alternatively be embodied in specialized hardware. Depending on the embodiment, the readable medium may be a hard disk drive, a compact disc, a digital video disc, or a tape drive.

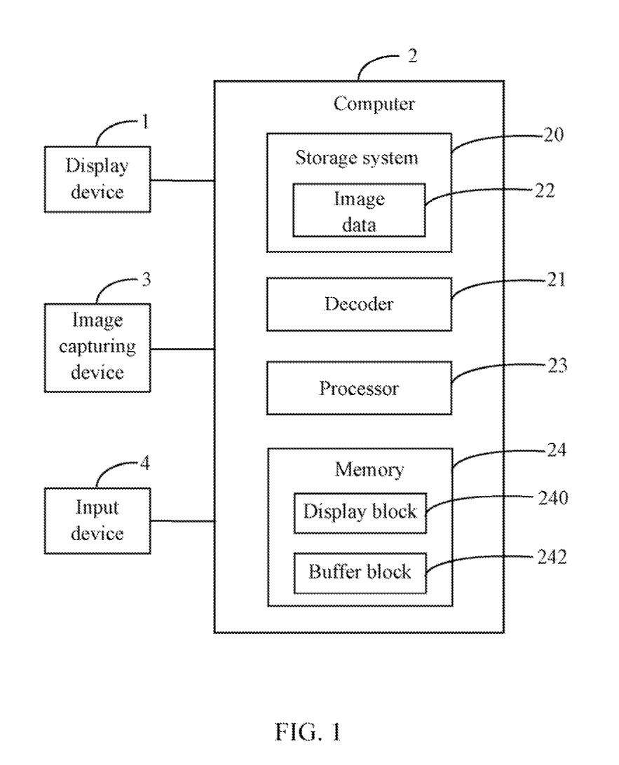

FIG. 1 is a block diagram of one embodiment of a computer 2 including a decoder 21. In some embodiments, the computer 2 further includes a memory 24, where the memory 24 may be divided into a display block 240 and a buffer block 242. The decoder 21 may be used to decode video bit streams in the display block 240 of the memory 24 to display decoded images directly. A detailed description will be given in the following paragraphs.

In some embodiments, the computer 2 is electronically connected to a display device 1, an image capturing device 3, and an input device 4. Depending on the embodiment, the display device 1 may be a liquid crystal display (LCD) or a cathode ray tube (CRT) display, for example.

The computer 2 further includes a storage system 20 to store various information, such as image data 22 captured by the image capturing device 3. In some embodiments, the image capturing device 3 may be an Internet Protocol (IP) camera.

The input device 4 is provided for manually editing an image displayed on the display device 1. In some embodiments, the input device 4 may be a keyboard, or a mouse.

In some embodiments, the decoder 21 includes one or more computerized instructions that are stored in the storage system 20. A processor 23 of the computer 2 executes the computerized instructions to implement one or more operations of the computer 2.

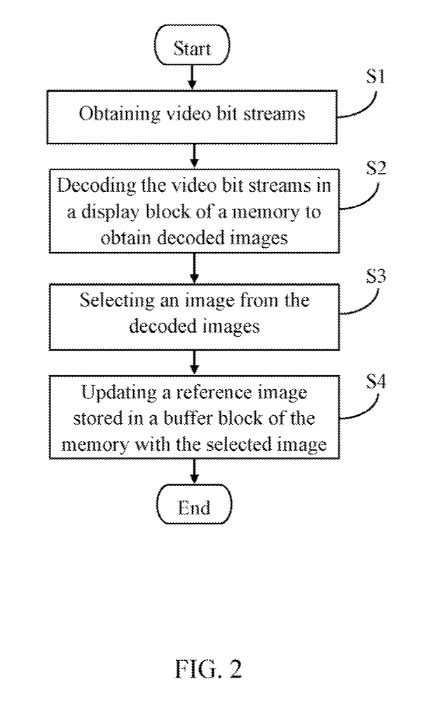

FIG. 2 is a flowchart of one embodiment of a method for improving display speed of decoding video bit streams. Depending on the embodiment, additional blocks may be added, others removed, and the ordering of the blocks may be changed.

In block S1, the decoder 21 obtains video bit streams (e.g., the image data 22) from the storage system 20. In some embodiments, the video bit streams may be encoded by an H.264 encoder. The decoder 21 may be an H.264 decoder.

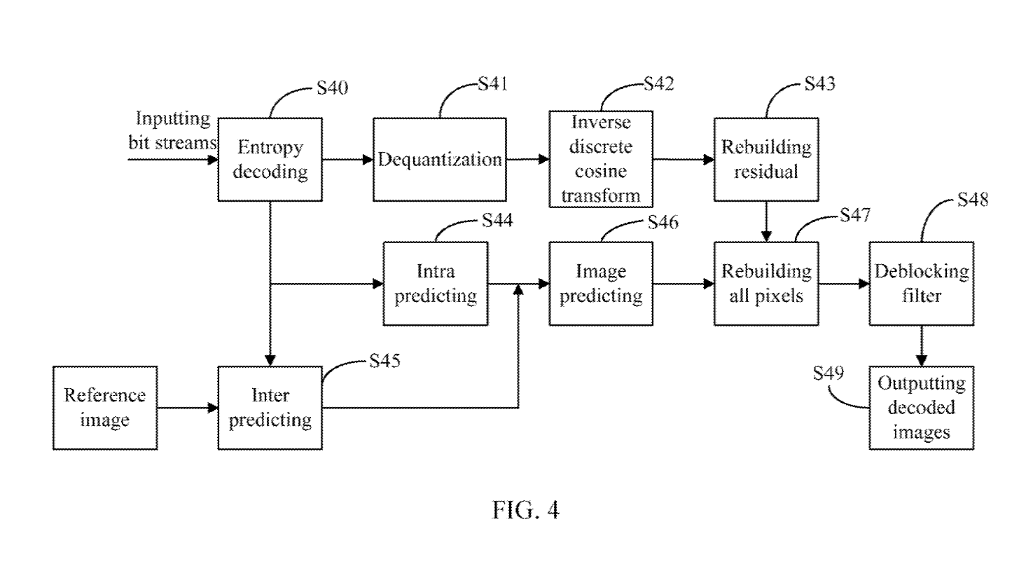

In block S2, the decoder 21 decodes the video bit streams in the display block 240 of the memory 24 to obtain decoded images. Detailed descriptions will be given in FIG. 4.

In block S3, the decoder 21 selects an image from the decoded images.

In block S4, the decoder 21 updates a reference image stored in the buffer block 242 of the memory 24 with the selected image.

FIG. 4 is a detailed flowchart of one embodiment of block S2 in FIG. 2. Depending on the embodiment, additional blocks may be added, others removed, and the ordering of the blocks may be changed.

In block S40, the decoder 21 performs an entropy decoding operation on the video bit streams, and then the procedure may go to block S41, S44, or S45 to perform different procedures.

In block S41, the decoder 21 performs a dequantization operation on the video bit streams after performing the entropy decoding operation.

In block S42, the decoder 21 performs an inverse discrete cosine transform operation on the video bit streams after performing the dequantization operation.

In block S43, the decoder 21 performs a rebuilding residual operation on the video bit streams after performing the inverse discrete cosine transform operation, and then the procedure goes to block S47 directly.

In block S44, the decoder 21 performs an intra predicting operation on the video bit streams after performing the entropy decoding operation in block S40, and then the procedure goes to block S46.

In block S45, the decoder 21 reads the reference image from the buffer block 242 of the memory 24, and performs an inter predicting operation on the video bit streams after performing the entropy decoding operation, and then the procedure goes to block S46.

In block S46, the decoder 21 performs an image predicting operation on the video bit streams after performing the intra predicting operation and the inter predicting operation, to obtain predicted images.

In block S47, the decoder 21 performs a rebuilding pixel operation on the predicted images and the video bit streams after performing the rebuilding residual operation.

In block S48, the decoder 21 performs a filtering operation on the predicted images and the video bit streams after performing the rebuilding pixel operation using a deblocking filter, to obtain the decoded images.

In block S49, the decoder 21 outputs the decoded images to the display block 240 of the memory 24.

In some embodiments, the entire blocks of S40-S49 are executed in the display block 240 of the memory 24. In other embodiments, the partial blocks of S45-S49 are executed in the display block 240 of the memory 24, and the other blocks of S40-S44 may be executed in other blocks of the memory 24.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for improving display speed of decoding video bit streams using a computer, the method comprising:
obtaining the video bit streams from a storage system of the computer by a decoder;
decoding the video bit streams in a display block of a memory of the computer to obtain decoded images by the decoder;
selecting an image from the decoded images by the decoder; and
updating a reference image stored in a buffer block of the memory with the selected image.

2. The method according to claim 1, wherein the video data are encoded by an H.264 encoder.

3. The method according to claim 2, wherein the decoder is an H.264 decoder.

4. The method according to claim 1, wherein the video bit streams are obtained by an image capturing device.

5. The method according to claim 4, wherein the image capturing device is an Internet protocol (IP) camera.

6. The method according to claim 1, wherein the step of decoding the video bit streams in a display block of the memory of the computer to obtain decoded images by the decoder comprises:
performing an entropy decoding operation on the video bit streams;
performing a dequantization operation on the video bit streams after performing the entropy decoding operation;
performing an inverse discrete cosine transform operation on the video bit streams after performing the dequantization operation;
performing a rebuilding residual operation on the video bit streams after performing the inverse discrete cosine transform operation;
performing an intra predicting operation on the video bit streams after performing the entropy decoding operation;
reading the reference image from the buffer block of the memory, and performing an inter predicting operation on the video bit streams after performing the entropy decoding operation;
performing an image predicting operation on the video bit streams after performing the intra predicting operation and the inter predicting operation, to obtain predicted images;
performing a rebuilding pixel operation on the predicted images and the video bit streams after performing the rebuilding residual operation;
performing a filtering operation on the predicted images and the video bit streams after performing the rebuilding pixel operation using a deblocking filter, to obtain the decoded images; and
outputting the decoded images to the display block of the memory.

7. A storage medium having stored thereon instructions that, when executed by a processor of a computer, cause the processor to perform a method for improving display speed of decoding video bit streams, the method comprising:
obtaining the video bit streams from a storage system of a computer by a decoder;
decoding the video bit streams in a display block of a memory of the computer to obtain decoded images by the decoder;
selecting an image from the decoded images by the decoder; and
updating a reference image stored in a buffer block of the memory with the selected image.

8. The storage medium according to claim 7, wherein the video data are encoded by an H.264 encoder.

9. The storage medium according to claim 8, wherein the decoder is an H.264 decoder.

10. The storage medium according to claim 7, wherein the video bit streams are obtained by an image capturing device.

11. The storage medium according to claim 10, wherein the image capturing device is an Internet protocol (IP) camera.

12. The storage medium according to claim 7, wherein the step of decoding the video bit streams in a display block of a memory of the computer to obtain decoded images by the decoder comprises:
performing an entropy decoding operation on the video bit streams;
performing a dequantization operation on the video bit streams after performing the entropy decoding operation;
performing an inverse discrete cosine transform operation on the video bit streams after performing the dequantization operation;
performing a rebuilding residual operation on the video bit streams after performing the inverse discrete cosine transform operation;
performing an intra predicting operation on the video bit streams after performing the entropy decoding operation;
reading the reference image from the buffer block of the memory, and performing an inter predicting operation on the video bit streams after performing the entropy decoding operation;
performing an image predicting operation on the video bit streams after performing the intra predicting operation and the inter predicting operation, to obtain predicted images;
performing a rebuilding pixel operation on the predicted images and the video bit streams after performing the rebuilding residual operation;
performing a filtering operation on the predicted images and the video bit streams after performing the rebuilding pixel operation using a deblocking filter, to obtain the decoded images; and
outputting the decoded images to the display block of the memory.

13. The storage medium according to claim 7, wherein the medium is selected from the group consisting of a hard disk drive, a compact disc, a digital video disc, and a tape drive.
